(19) United States
(12) Patent Application Publication
(10) Pub. No.: US 2011/0182496 A1
(43) Pub. Date: Jul. 28, 2011

(54) DEFECT CHECK METHOD AND DEVICE THEREOF

(76) Inventors: Kaoru Sakai, Yokohama (JP); Shunji Maeda, Yokohama (JP)

(21) Appl. No.: 13/058,223

(22) PCT Filed: Jul. 13, 2009
(86) PCT No.: PCT/JP2009/063014

§ 371 Date: Apr. 15, 2011

(30) Foreign Application Priority Data
Aug. 25, 2008 (JP) 2008-214802

(51) Int. Cl. G06K 9/00

(52) U.S. Cl. 382/145

(57) ABSTRACT

A defect inspection method for inspecting a defect(s) on an object to be inspected, within a step for determining parameter includes: a step for extracting a defect candidate on the object to be inspected with using said discriminant function with determining an arbitrary parameter; and a step for automatically renewing the parameter of said discriminant function, upon basis of teaching of defect information relating to the defect candidate, which is extracted in the step for extracting the defect candidate.

### TECHNICAL FIELD

The present invention relates to a check or inspection for detecting a minute pattern defect and/or a foreign substance upon basis of a result of comparison, while comparing an image of an object to be inspected (i.e., a check image), which is obtained with using a light, a laser or an electron beam, etc., with a reference image, and in particular, it relates to a defect check or inspection method and a device thereof being suitable for conducting a visual inspection upon a semiconductor wafer, a TFT and/or photo mask and so on.

### BACKGROUND OF THE INVENTION

As the conventional technology for conducting a defect detection with comparison between a detection image and a reference image is already known a method, which is described in a Patent Document 1. In this, an image of an object to be inspected, on which patterns are aligned repeatedly, is taken by a line sensor, sequentially, to be compared with an image delayed by an amount of a repetitive pattern pitch, and thereby detecting a discrepancy portion to be a defect.

Explanation will be made on a semiconductor wafer, for example, by referring to FIGS. 2(a) and 2(b), as an example of the object to be inspected, which is used in the conventional defect check. FIG. 2(a) is a schematic diagram for showing the structure of the semiconductor wafer 11, and FIG. 2(b) is a schematic diagram for showing the structure of a chip 20 on the semiconductor wafer. On the semiconductor wafer 11 are aligned a large numbers of similar patterns, regularly, as is shown in FIG. 2(a). In areas 21 to 25 corresponding to the same positions on each of the chips, basically, there are formed the same patterns. On a memory element, such as, a DRAM, etc., for example, each chip 20 can be roughly separated into a memory mat portion 20-1 and a peripheral circuit portion 20-2, as is shown in FIG. 2(b). The memory mat portion 20-1 is an aggregate of the small or minute repeating portions (i.e., cells), and the peripheral circuit portion 20-2 is basically an aggregate of random patterns. In general, the memory mat portion 20-1 is high in the pattern density thereof, and then an image obtained therefrom comes to be dark. On the contrary to this, the peripheral circuit portion 20-2 is low in the pattern density thereof, and the image obtained thereform come to be bright.

In the conventional defect check, in particular, within the peripheral circuit portion 20-2, brightness (i.e., a brightness value) of the images is compared between the positions corresponding to the neighboring chips, i.e., the area 22 and the area 23, etc., in FIG. 2(a), for example, and a portion where a difference thereof is larger than a threshold value is detected as a defect. Hereinafter, such the check or inspection is described by “chip comparison”. Within the memory mat portion 20-1, the brightness of the images is compared between the neighboring cells within the memory mat portion, and a portion where a difference thereof is larger than a threshold value is detected as a defect. Hereinafter, such the check or inspection is described by “cell comparison”.
Patent Document 1: Japanese Patent Laying-Open No. Hei 05-264467 (1993)

### DISCLOSURE OF THE INVENTION

On the semiconductor wafer, being an object to be inspected, a delicate difference is generated in a film thickness on the patters even if they are neighboring to each other, due to flattering or planarization through CMP, and there is a local difference (i.e., brightness difference) on the image between the chips. If detecting a portion having the brightness difference being equal to or greater than a specific threshold value “th” as the defect, as is in the conventional method, an area or region where the brightness differs from due to such difference of the film thickness is also detected as the defect. However, inherently this should not be detected as the defect. Thus, it is erroneous information. Conventionally, as one method for avoiding generation of the erroneous information, the threshold value for defect detection is determined to be large. However, this lowers the sensitivity, i.e., it is impossible to detect the defect having the difference value being equal to or less than that.

Also, the difference of brightness due to such difference of the film thickness may occur, among the chips aligned as shown in FIG. 2, only between specific chips within a wafer, or only between specific patterns within a chip; however, if fitting the threshold value to those local areas, then an entire sensitivity of the detection is lowered down, remarkably. Further, determining the threshold value depending on the brightness for each local area brings about complicatedness or troublesome in an operation, and therefore this is not desirable for a user.

Also as a factor of hampering the sensitivity is a difference of brightness between the chops, caused due to variation of thickness of the patterns. In the conventional comparison check with using the brightness, if there is such variation of the brightness, it results into a noise when conducting the check.

On the other hand, the defects are various in the kinds thereof, and they can be divided roughly, into a defect not necessary to be detected (i.e., can be considered as a normal pattern noise) and a defect tp be detected. According to the present invention, what is detected as the defect, erroneously, in spite of the fact that it is not defect (i.e., erroneous information), and the normal pattern noise, etc., they are called “non-defect”, collectively. In the visual inspection, it is demanded to extract only the defect, which the user wishes, from among an enormous number of defects; however, with comparison between the brightness difference and the threshold value, it is difficult to achieve this. Also, it is very often that a view is changed for each kind of detects, upon factors depending on the object to be inspected, such as, a material, surface roughness, sizes, depth, etc., and also combination with the factors depending on a detecting system, such as, a lighting condition, etc., therefore it is difficult to set up the condition for extracting only the defect, which the user desires.

An object of the present invention is, for dissolving the drawbacks of such conventional inspection technology, within a defect check apparatus for determining the discrepancy portion of an image as a defect, comparing the images of corresponding areas or regions of patterns, which are formed to be the same pattern, to achieve a defect inspection for detecting the defect (s) desired by the user with high-sensitivity and at high-speed, which are buried in noises and the defects not necessary to be detected, without conducting the troublesome setup of the threshold value.

### Means for Dissolving the Problem(s)

Brief explanation of an outlook of a representative one of the inventions disclosed herein will be as follows:

(1) A defect inspection method for inspecting a defect(s) on an object to be inspected, comprising the following steps of:

a step for obtaining detected image of a pattern of said object to be inspected with irradiation under a predetermined optical condition upon said object to be detected; a step for determining a parameter of discriminant function to be formed upon basis of feature quantity, which is calculated from detected image; and a step for detecting a defect on said object to be inspected, with using said discriminant function to be formed upon basis of the parameter, which is determined in said step for determining the parameter, wherein said step for determining the parameter includes: a step for extracting a defect candidate on said object to be inspected with using said discriminant function with determining an arbitrary parameter; and a step for automatically renewing the parameter of said discriminant function, upon basis of teaching of defect information relating to said defect candidate, which is extracted in said step for extracting said defect candidate.

(2) The defect inspection method defined in the (1), wherein the parameter of said discriminant function is automatically renewed while teaching only that said defect candidate is a non-defect, within said step for automatically renewing said parameter.

### Effect(s) of the Invention

According to the present invention, it is possible to detect the kind of defects, which the user wishes, with high-sensitivity, while teaching the non-defect.

### BRIEF DESCRIPTION OF THE DRAWINGS

FIG. 1 is a block diagram of the structure of a defect check apparatus, according to the present invention;

FIGS. 2(a) and 2(b) are views for showing an example of the structures of an object to be inspected (e.g., a semiconductor wafer);

FIG. 3 is a view for showing an embodiment of the defect check apparatus according to the present invention;

FIG. 4 is an explanatory view of a detection image, a reference image and a difference image of those;

FIGS. 5(a) is a histogram of brightness difference of the detection image and the reference image, and 5(b) is a view for showing an example of a polygonal discriminant function;

FIG. 6 is a view for showing an example of a processing flow within a defect candidate detecting portion;

FIGS. 7(a) and 7(b) are views for showing an example of a method for setting up the threshold-value-surface function, within the defect candidate detecting portion;

FIG. 8 is a view for showing an example of a screen displayed on a monitor of a user interface portion when setting up the threshold-value-surface function, within a defect candidate detecting portion;

FIG. 9 is a view for showing an example of a processing flow within a defect extractor portion;

FIG. 10 is a view for showing an example of a method for setting up the threshold-value-surface function, within the defect candidate detecting portion;

FIGS. 11(a) to 11(c) are views for showing an embodiment of a defect inspection method, according to the present invention;

FIGS. 12(a) to 12(d) are views for explaining a defect, which cannot be detected through the comparison inspection with a neighboring chip;

FIG. 13 is a view for showing a variation of the defect inspection method, according to the present invention;

FIGS. 14(a) and 14(b) are views for showing a variation of the defect inspection method, according to the present invention;

FIG. 15 is a view for showing a variation of the defect check apparatus, according to the present invention;

FIG. 16 is a view for showing a variation of the defect inspection method, according to the present invention; and

FIGS. 17(a) and 17(b) are views for showing a variation of the defect inspection method, according to the present invention.

### EXPLANATION OF MARKS

2 memory
3a, 3b scattering light
11 semiconductor wafer
12 X-Y-Z-θ stage
13 mechanical controller
15a, 15b lighting portion
16 detection optic system
17 detector portion
18-1 pre-processor portion
18-2 defect candidate detector portion
18-3 defect extractor portion
18-4 defect classifier portion
18-5 teaching data setup portion
18 image processor portion
19-1 user interface portion
19-2 memory device
19 total controller portion
20-1 memory mat portion
20-2 peripheral circuit portion
20 chip
21, 22, 23, 24, 25 area
31, 41 detection image
32, 42 reference image
43 difference image
44 brightness signal of detection image
45 brightness signal of reference image
46 difference image
47 superimposing of brightness signals between detection signal and reference signal
51, 52 threshold value
53 large defect
54 minute defect
55 normal pattern noise
56 discriminant
71 object to be inspected
81, 88 screen
82 defect map
83 defect list
84 respective defect display screen
85 observation display screen
86 teaching button
87 threshold value setup button
130 detection optic system
131 image sensor
161a, 161b detection image
161a′, 161b′ reference image
1101, 1104 envelope
1102, 1103, 1105, 1106 point
1301 normal area
1401, 1402 envelope surface
1701 broken line
1702 area
1703 pixel

### DETAILED DESCRIPTION OF THE PREFERRED EMBODIMENTS

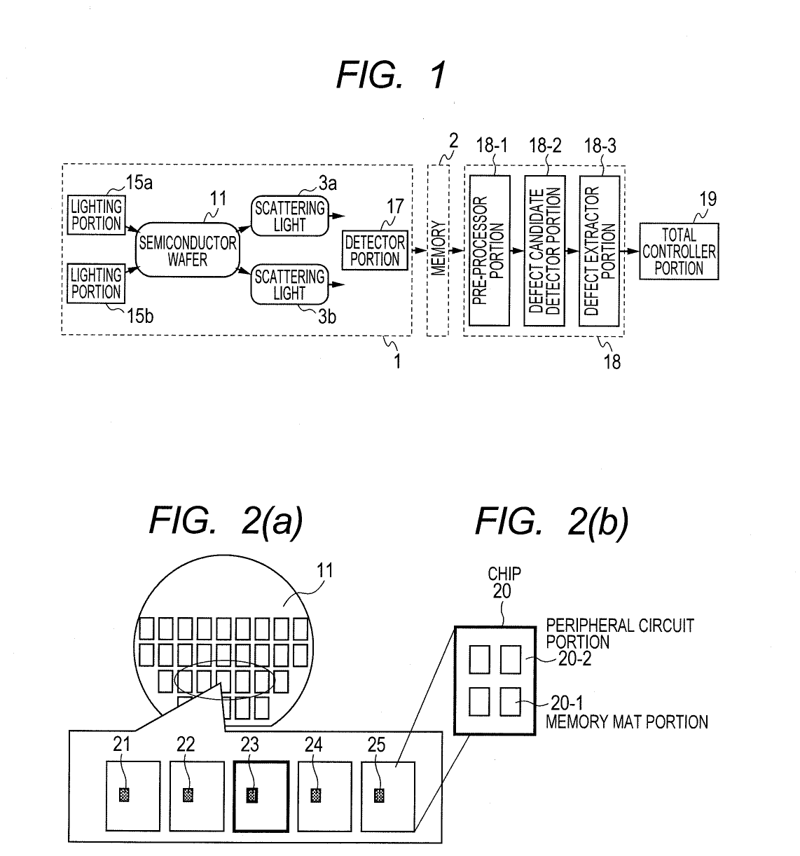

Hereinafter, an embodiment according to the present invention will be fully explained by referring to FIG. 1 through FIG. 17 attached herewith, showing an example of a defect check apparatus with a dark-field illumination targeting on a semiconductor wafer as an object to be inspected.

FIG. 1 is a diagram for showing the structures of the defect check apparatus according to the present invention. An optic portion 1 is so constructed as to have plural numbers of lighting portions 15a and 15b and a detector portion 17. The lighting portions 15a and 15b irradiate illumination lights, each having an optic condition different from each other, upon an object to be inspected (e.g., a semiconductor wafer 11) respectively. Due to the illumination lights by means of the lighting portion 15a and 15b, scattering lights are generated, respectively, and are detected in the form of a scattering-light intensity signal by means of the detector portion 17. The scattering-light intensity signal detected is stored in a memory 2, once, and is inputted into a image processor portion 18.

The image processor portion 18 is constructed, appropriately, so as to have a pre-processor portion 18-1, a defect candidate detector portion 18-2, and a defect extractor portion 18-3 therein. The scattering-light intensity signal inputted into the image processor portion 18 is conducted with a signal correction and image dividing, etc., which will be mentioned later. Within the defect candidate detector portion 18-2, a process is treated, which will be mentioned later and thereby detecting a defect candidate, from the image produced in the pre-processing portion 18-1. In the defect extractor portion 18-3, from image information of defect candidates, which are detected within the defect candidate detector portion 18-2, the defect kinds and noises determined unnecessary by a user are excluded, while the defect kind(s) determined to be necessary by the user is/are extracted from (a post-step); thereby to be outputted to a total controller portion 19. In FIG. 1, the scattering lights 3a and 3b are detected by the detector portion 17, in common, for example; however, they may be detected by two (2) sets of detector portions, respectively. Also, there is no need of providing the lighting portions and the detector portions are provided by two (2) sets thereof, respectively, and may be one (1), or three (3) or more than that.

The scattering lights 3a and 3b indicate distributions of the scattering lights, which are respectively generated corresponding to the lighting portions 15a and 15b. If the optical condition of the illumination light by means of the lighting portion 15a differs from the optical condition of the illumination light by means of the lighting portion 15b, the scattering light 3a and the scattering light 3b, each generating therefrom, differ from each other. In the present specification, an optical feature and a feature of the scattering light generating by a certain illumination light is called a “scattering light distribution of that scattering light”. The scattering light distribution indicates, in more details thereof, distribution of optical parameter values, such as, intensity, amplitude, a phase, a polarization, a wavelength, a coherency, etc., with respect to an emission portion, an emission direction, and an emission angle.

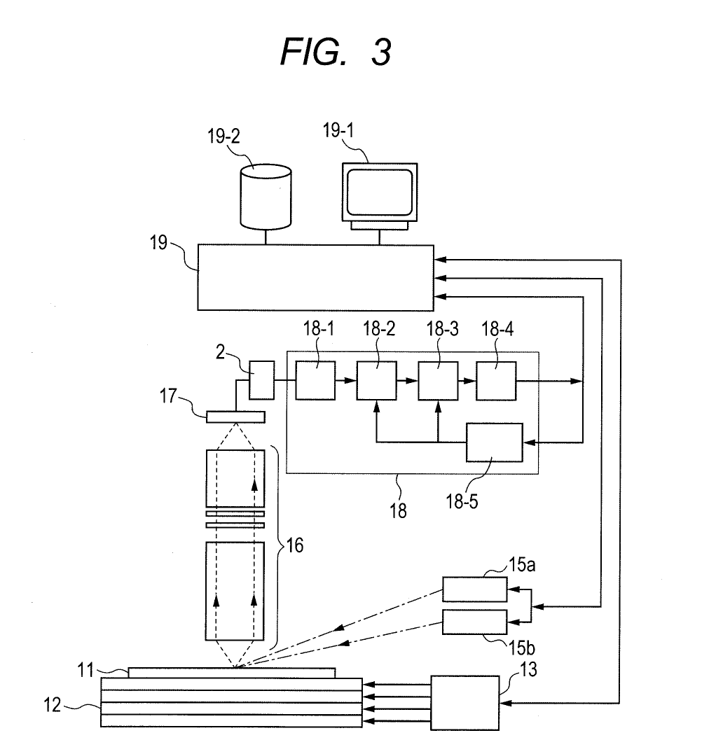

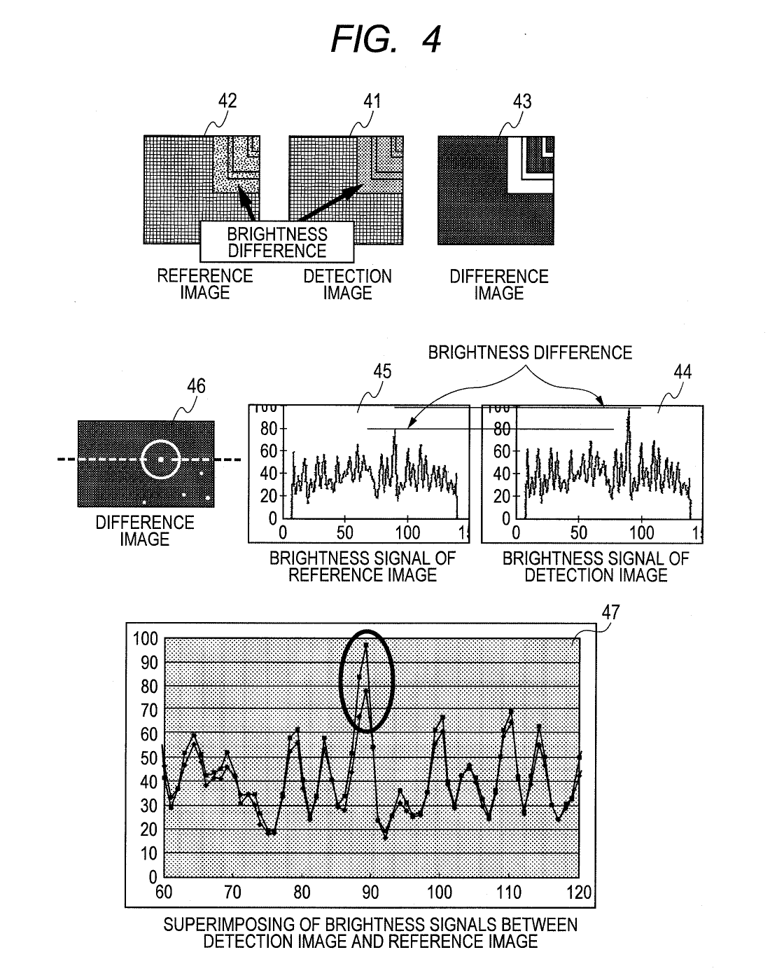

Next, a schematic diagram of the defect check device is shown in FIG. 3, as an example of the concrete check device for achieving the structures shown in FIG. 1.

The check device, according to the present invention is constructed, appropriately, so as to include plural numbers of lighting portions 15a and 15b for irradiating the illumination lights upon the object to be inspected (e.g., the semiconductor wafer 11), a detecting optic system 16 (e.g., an upper detector system) 16 for forming an image of scattering light in the vertical direction from the semiconductor wafer 11, the detector portion 17 for receiving the formed optical image thereon and converting it into an image signal, the memory 2 for storing therein the image signal obtained, the image processor portion 18 and the total controller portion 19. The semiconductor wafer 11 is mounted on a stage (e.g., an X-Y-Z-θ stage) 12, which can move and rotate within a XY plane and move in Z direction, and the X-Y-Z-θ stage 12 is driven by a mechanical controller 13. In this instance, mounting the semiconductor wafer 11 on the X-Y-Z-θ stage 12 and detecting the scattering lights from a foreign matter(s) on the target to be inspected while moving the X-Y-Z-θ stage 12 in the horizontal direction, a detection result can be obtained in the form of a two-dimensional (2-D) image.

As the illumination light source of the lighting portion 15a or 15b may be applied a laser, or a lamp in the place thereof. Also, the wavelength of the light of the illumination light source may be short wavelength, or a light of wide band wavelength (e.g., a white light). In case of applying the short wavelength light, for the purpose of increasing a resolution power of the image to be detected (i.e., for detecting a minute defect), it is possible to apply a Ultra Violet Light (e.g., UV light). In case of applying a laser as a light source, and in particular, where that is a laser of a single wavelength, it is also possible to provide a means for reducing the coherence (not shown in the figure) on the lighting portion 15a or 15b.

The detector portion 17, applying an image sensor of time-delay integration type (i.e., a Time Delay Integration Image Sensor: TDI image sensor), which is built up by aligning plural numbers of one-dimensional (1-D) image sensors in 2-D manner, as the image sensor thereof, and thereby transmitting a signal detected by each 1-D image sensor to a next-stage 1-D image sensor, in synchronism with movement of the X-Y-Z-θ stage 12, to be added with, is able to obtain a 2-D image with relatively high-speed and high-sensitivity. As this TDI image sensor, with applying a parallel output type sensor having plural numbers of output taps, it is possible to process outputs from the sensor in parallel with, and thereby enabling further high-speed detection.

The image processor portion 18 is that for extracting a defect (s) on the semiconductor wafer 11, being the object to be inspected, and it is constructed, appropriately, so as to include the pre-processing portion 18-1 for conducting image correction, such as, shading correction, dark level correction, etc., upon the image signal inputted from the detector portion 17, thereby dividing it into images, each having sizes of a constant unit, the defect candidate detector portion 18-2 for detecting a defect candidate(s) from the corrected and divided images, the defect extractor portion 18-3 for extracting the defect (s) other than the unnecessary defects and the noises, which the user designates, from the defect candidates detected, a defect classifying portion 18-4 for classifying the defect (s) extracted, depending on the defect kinds, and a teaching data setup portion 18-5 for setting teaching data, being inputted from an outside, into the defect candidate detector portion 18-2 and the defect extractor portion 18-3, upon receipt thereon.

The total controller portion 19 comprises a CPU (i.e., being built within the total controller portion 19) for executing various kinds of controls, and it is connected, appropriately, with a user interface portion 19-1 having a display means and an input means, for display the image of defect candidate (s) detected, the image of the defect, which is finally extracted, etc., upon receipt of the teaching data (though will be mentioned later, patterns from the user, which can be detected in a large amount, such as, the normal patter noise, the unnecessary defects, etc., for example) and also design information of the semiconductor wafer 11, and a memory device 19-2 for memorizing feature quantities and images or the like of the detected defect candidates therein. The mechanical controller 13 drives the X-Y-Z-θ stage 12 upon basis of control instructions from the total controller portion 19. Further, the image processor portion 18, the detecting optic system 16, and so on, are also driven upon the instructions from the total controller portion 19.

Herein, on the semiconductor wafer 11, being the object to be inspected, as is shown in FIGS. 2(a) and 2(b), there are aligned or arranged a large number of chips 20, being similar in the pattern, regularly, each having the memory mat portion 20-1 and the peripheral circuit portion 20-2. The total controller portion 19 takes an image of the chip therein, sequentially, while moving the semiconductor wafer 11 on the X-Y-Z-θ stage 12, but in synchronism therewith, and compares the feature quantity between a detection image and a reference image, for the detection image, at the same position on the chips aligned regularly, for example, for the area 23 of the detection image shown in FIG. 2(a), with treating digital image signals of the areas 21, 22, 24 and 25 as the reference image, and thereby extracting the defect(s).

On the semiconductor wafer 11, as was mentioned above, are formed the same patterns, regularly, and although the images of the areas 21 through 25 should be properly the same, but actually, the brightness differs from between the images. By referring to FIG. 4, explanation will be made on the difference between the detection image 41, the reference image 42 and the difference of those images. A difference image 43 between the detection image 41 and the reference image 42 indicates the brightness difference between the detection image 41 and the reference image 42 of the corresponding area of the neighboring chip. The larger the brightness difference, a pixel is presented the brighter. The semiconductor wafer 11 is made up with multi-layer films, and because of the difference of film thickness between the chips, a large difference of brightness is generated between those images; however, this is normal, and there is no necessity of detection thereof. Thus, it is the normal noise pattern. With the conventional comparison check, comparison is made on the brightness between the corresponding pixels, and the pixels having the brightness difference larger than the threshold value, which is determined in advance, is detected as the defect candidate; however, if determining the threshold value to be high, in such that no noise unnecessary to be detected can be detected, such as, a difference image 43, for example, also the detect having small brightness difference can be overlooked.

Further, as a primary factor of the noises, there are some, which are caused due to variation of thickness of the patterns. Those expressing waveforms of the brightness signals of the images of the neighboring chips are a brightness signal 44 of the detection image and a brightness signal 45 of the reference image, respectively, and that laying one on top of the other is a superimposing 47 of brightness signals between the brightness signal 44 of the detection image and the brightness signal 45 of the reference image. As is a difference image 46 between the brightness signal 44 of the detection image and the brightness signal 45 of the reference image, when the difference of brightness between the images at a specific pixel due to the variation of thickness of the patterns is equal to or greater than the threshold value, it can be detected as the defect. Further, if advancement is made on the high-sensitivity of the inspection device, a number of the defects and the kinds of defects are also huge, and therefore, if the user conducts a high-sensitivity inspection with comparison of the brightness, while setting the threshold value to be low, then almost of the defect candidates come to be the noises and the unnecessary defects; i.e., it is difficult to find out the defect(s) desired by the user from among the defect candidates.

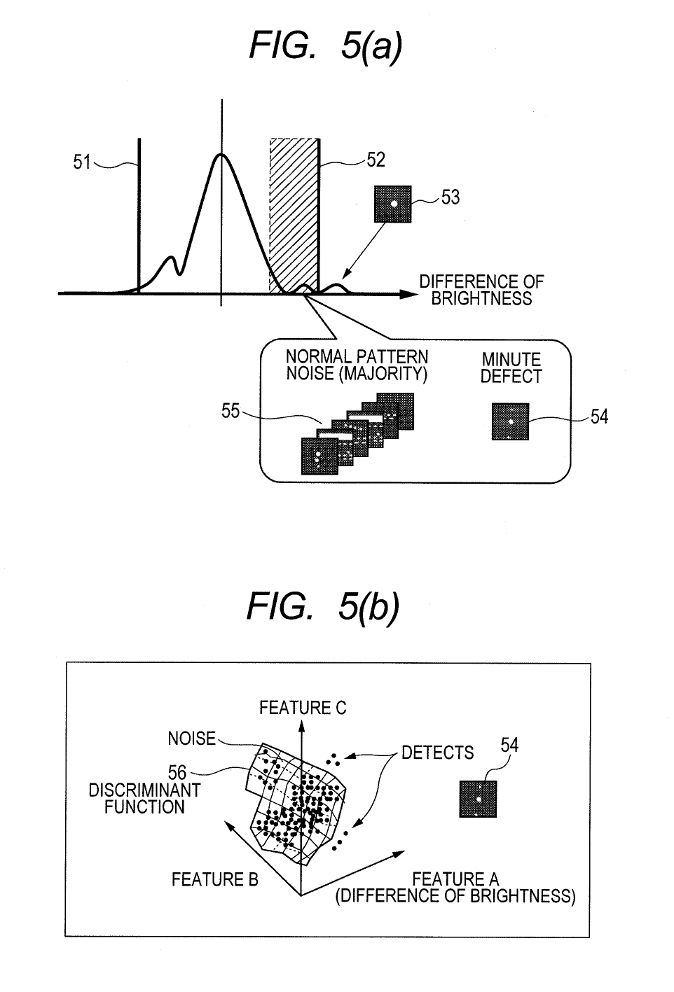

FIG. 5(a) shows a histogram of brightness differences of the detection image and the reference image. Since the detection image has a bright portion and/or a dark portion, comparing to the reference image, the brightness difference has both, positive and negative values. In case of detecting the defect(s) with comparison of the brightness, as is in the conventional technology, the threshold values 51 and 52 are determined on the plus side and the minus side of the histogram, respectively, and that lying outside of those results to be detected as the defect candidate. Those threshold values can be setup by the user, manually, while watching a manner of appearance of the noises, or can be set up automatically, parametrically, from distribution values of the histogram. If determining the threshold values 51 and 52 outside so that no noise can be detected, the sensitivity comes to be low, and then only a large defect can be detected. If determining the threshold values inside much more, then the sensitivity comes to be high, then the defect can be detected even from a meshed portion of the histogram. With this, it is possible to detect the defect being minute much more, but at the same time it happens that the normal pattern noises 55 are also detected in a large amount thereof; i.e., although it is possible to detect the minute defect 54 desired by the user, but it is buried within the normal pattern noises, then it is impossible to specify that from among the defect candidates.

For this reason, according to the present invention, in particular, with the defects, which cannot be discriminated only from the difference of brightness, and the normal pattern noises, as is shown in FIG. 5(b), the pixel coming off from a polygonal threshold value face function 56 is detected as the defect, with using plural numbers of feature quantities A, B and C, within a multi-dimensional feature space, and thereby suppressing the noises and also enabling to detect the defect (s) only. Herein, within the multi-dimensional feature space, it is necessary to set up the threshold value face function for specify the pixel coming off, so that it includes the normal pattern noises therein, as is the polygonal threshold value face function 56 shown in FIG. 5(b). Also, since the minute defect, as a reference for determining the polygonal threshold value face function 56, is buried in the noises, then it is also difficult to set up the threshold value, manually while confirming the manner of appearance of the defects. Then, according to the present invention, with teaching a normal pattern area, occupying a large number thereof, and can be specified easily, as well as, the normal patter noises, the polygonal threshold value face function 56 for detecting the defect (s) is automatically produced. Hereinafter, explanation will be given on a flow of processes thereof.

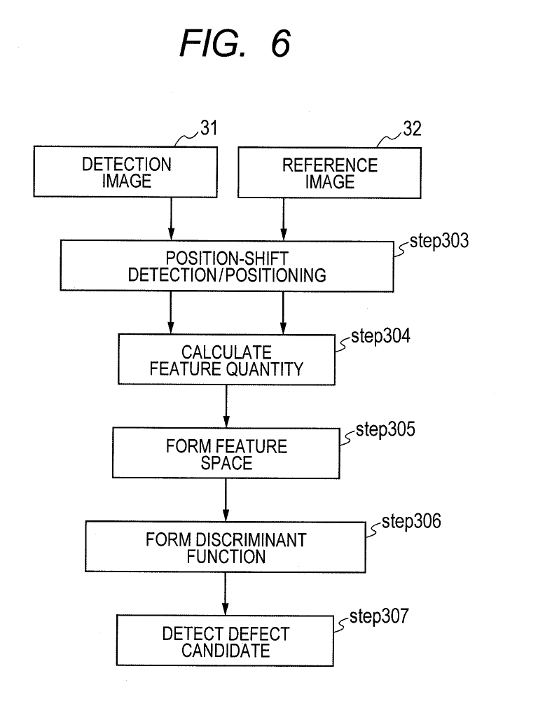

FIG. 6 shows an example of the flow of processes within the defect candidate detector portion 18-2 for detecting the defect candidates with using the feature quantities, which are calculated upon basis if the detection image 31 on the object to be inspected and the reference image 32.

First of all, detection is made on a positional shift volume between the detection image 31 to be the inspection target and the reference image 32 corresponding thereto (herein, as an image of the neighboring chip is used one attached with the reference numeral 22 in FIG. 2(a)), and thereby conducting positioning thereof (step 303). Detection of the positional shift volume is made by a method, in common, such as, obtaining such a shift volume that a square addition of the brightness differences between the one image and the other image, while shifting the former, or obtaining such a shift volume that a normalizing correlation coefficient comes to the maximum.

Next, for each pixel of the detection image 31, on which the positioning is conducted, the feature quantity is calculated between it and the pixel of the reference image corresponding thereto (step 304). As an example thereof, there are (1) brightness, (2) contrast, (3) shading or tint difference, (4) a brightness distribution value of the pixel in vicinity, (5) a correlation coefficient, (6) increase/decrease of brightness comparing to the pixel in vicinity, and (7) a secondary differential value, etc. The example of those feature quantities can be expressed as follows, assuming that the brightness of each point on the detection image is f(x, y), and the brightness of the reference image corresponding thereto is g(x, y), respectively:

Brightness; f(x,y), or {f(x,y)+f(x,y)}/2 (Eq. 1)

Contrast; max {f(x,y)}, f(x+1,y), f(x,y+1),f(x+1,y+1)}−min {f(x,y)},f(x+1,y),f(x,y+1),f(x+1, y+1)} (Eq. 2)

Tonic difference; f(x,y)−g(x,y) (Eq. 3)

Distribution; [Σ{f(x+I,y+j)²−Σ{f(x+I,y+j)²/M}/(M−1) i,j=−1,0,1M=9 (Eq. 4)

As the feature quantities, various ones indicating features of the noises and the defect kinds can be used herein, other than the above-mentioned (1) to (7).

And, among those feature quantities is formed the feature space by plotting each pixel within the space, using several or all feature quantities as axes thereof (step 305). On this feature space is formed the discriminant function, which sets up parameters (will be mentioned later) thereon, arbitrarily (step 306), and detection is made on the pixel as the defect candidate, which is plotted outside the discriminant function, among the pixels building up the feature space, i.e., the pixel having an off value in the meaning of the features thereof (step 307).

Herein, because the image of the semiconductor wafer 11 can be obtained, continuously, accompanying with movement of the X-Y-Z-θ stage 12 shown in FIG. 3, it is divided into small images, each being a specific unit, and thereby a defect candidate detection process is executed thereon. For this reason, the defect candidate detector portion 18-2 is constructed with plural numbers of processors. And, a set of small images divided, at position corresponding to each chip, is inputted into the same processor, and thereby each processor executes the process, in parallel with.

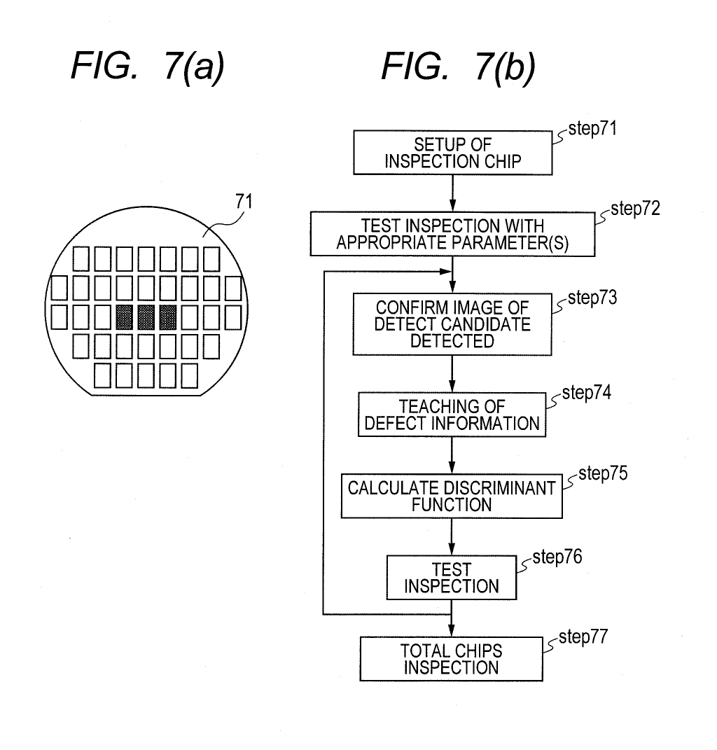

Next, a method for setting the discriminant function for detecting an off pixel will be explained, by referring to FIGS. 7(a) and 7(b). FIG. 7(a) shows an object 71 to be inspected, which is used for setting the discriminant function, and FIG. 7(b) shows an example of a flow for setting up the discriminant function.

First of all, an inspection chip is set to be used in a setup of the discriminant function (step 71). When setting up the discriminant function, for the purpose of reducing a process time, an area of the object to be inspected (i.e., a black painted portion in FIG. 7(a)) may be restricted, or all chips (i.e., a total surface of the semiconductor wafer) may be an inspection target without placing an area restriction thereon.

Next, with the parameters of an appropriate discriminant function, or the parameters of the discriminant function being set up by default, the defect candidate detection process shown in FIG. 6 is executed upon the object 71 to be inspected (step 72). Herein, the detection of the defect candidate may be made through simple comparison of the brightness thereof. This is called a “test inspection”.

The user confirms on whether it is the defect or non-defect, while observing an image of the defect candidate, which is detected through the test inspection (step 73). The confirmation may be made on the image, which can be obtained by an lighting optic system of the device according to the present invention, or that, which can be obtained by other detecting system, such as, an image formed by electron beams, for example, as far as distinction can be made between the defect and the non-defect. Also, according to the present invention, when executing the defect candidate detection process, since the pixel to be the defect candidate and small images in the peripheral portions thereof are cut out from the detection image, and the small images at the position corresponding to thereto are cut out from the reference image, on a set, and they are reserved, therefore confirm can be made on the image of those. And, teaching of the defect information upon basis of the defect candidate, which is confirmed, is made (step 704). Herein, the defect information is the information indicative of whether the pixel extracted as the defect candidate is either the non-defect or the defect, and the user teaches the teaching data, with using the defect information on whether it/they is/are the defect(s) or the non-defect(s), for an arbitrary number of defect candidate(s).

Upon basis of the teaching data, calculation is automatically executed on such discriminant function that it does not detect the non-defect (step 75), and with using the discriminant function calculated, the defect candidate detection process (e.g., the test inspection) shown in FIG. 6 is executed upon the object to be inspected (step 76).

Since it is high in possibility that almost of the defect candidates to be detected are the non-defects, if executing the defect candidate detection process with using appropriate parameters, then basically, only the non-defect are designated; however, if including the defect (s) therein, it is also possible to teach the defect. Upon the defect candidate (s) to be detected, by repeating the steps 73 to 76 until when no non-defect is detected as the defect candidate, and thereby renewing the parameters, automatically, the parameters of the discriminant function are determined. And, with using the discriminant function formed upon basis of the parameters determined, the defect candidate detection process is conducted on the total chips (i.e., the entire surface of the semiconductor wafer (step 77).

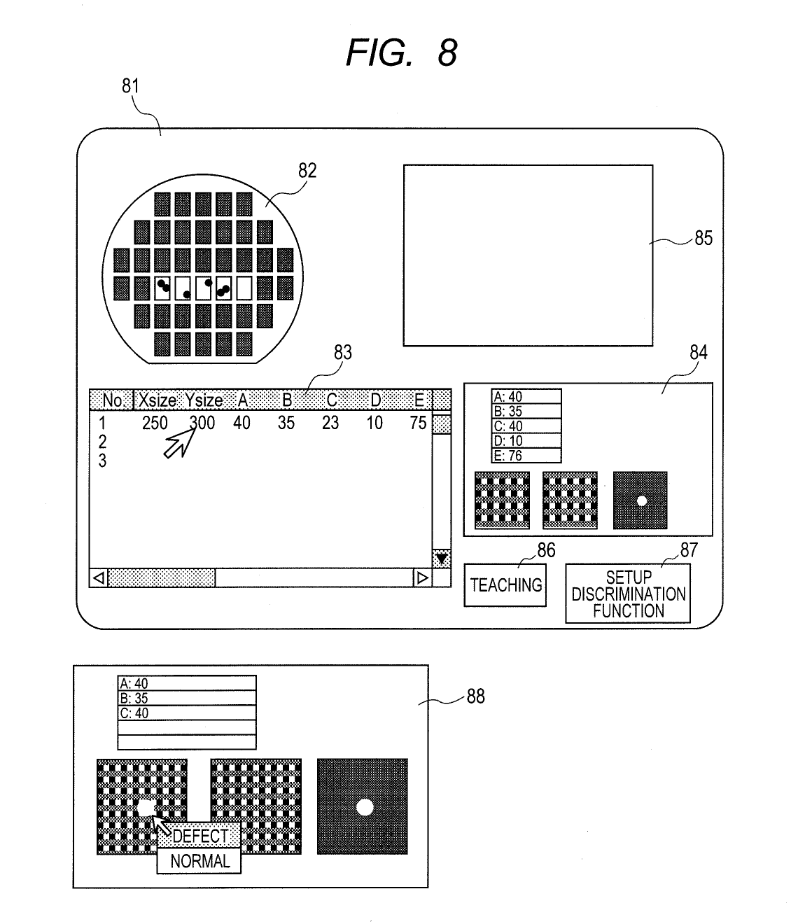

FIG. 8 shows an example of screen 81 and 88, which are displayed on a monitor of the user interface portion when setting the discriminant function.

The screen 81 is constructed, appropriately, so as to have a defect map 82 for showing positions of the defect candidates on the semiconductor wafer, a defect list for displaying all feature quantities or the like, such as, sizes of the defect candidates detected, etc., for example, an individual defect displays screen 84 for displaying a defect candidate image (e.g., a defect portion, a reference portion, a difference image, etc.), which is selected from the defect map 82 or the defect list 83, and the feature quantity thereof, an observation image display screen 85 through other lighting optic system, a teaching button 86 for teaching of whether each defect candidate is the non-defect (normal) or the defect, and a discriminate function setup button 87 for renewing the discriminate function, automatically.

On the defect map 82 is displayed an inspection object of the test inspection, brightly (herein, central five (5) chips), and the detected detect(s) is/are plotted thereon. On the individual defect display screen 84 are displayed the defect candidate image (e.g., a defect portion, a reference portion, a difference image, etc.) and the feature quantity thereof, by pointing out the defect on the defect map 82 or the defect list 83, individually, by a mouse. The teaching button 86 is used when the user teaches of whether the defect candidate is the defect or the non-defect, while observing the observation image display screen 85. Also, the screen 88 is used when the user makes the teaching of whether the defect candidate is the defect or the non-defect, sequentially, while designating several or several-tens numbers of the detect candidates, after selecting the teaching button 86 by the mouse. When the discriminate function setup button 87 is selected, at the time-point when the teaching is completed, then calculation is executed on the discriminant function.

Next, explanation will be made about an example of the discriminant function. According to the present invention, upon an assumption that it is not easy to find out the defect, which is needed by the user, truly, from the defect candidates detected, in particular, if a number of the defect candidates to be detected increases accompanying with an advancement of the high-sensitivity of the device, the teaching is made of only the non-defects, which can be found out easily, and thereby to enable calculation of the discriminant function for discriminating between the defect and the non-defect. As a method thereof, it is treated as a discrimination problem of 1^{st} class, in general, and there are various kinds thereof. As one example thereof, assuming that the feature of a non-defect pixel, upon which the teaching is made, has a normal distribution, there is a method for discrimination, with obtaining a probability that the pixel, being the object to be inspected, is non-defect pixel. Assuming that “d” pieces of the feature quantities of “n” pieces of non-defect pixels, upon which the teaching is made, x1, x2, . . . , xn, then a discrimination function φ for detecting a pixel having the feature quantity x as the defect candidate can be given by the following equations, Eq. 5 and Eq. 6:

Probability density function of x

$$p ( x ) = \frac{1}{{( 2 π )}^{\frac{d}{2}} \sqrt{\vert \sum \vert}} exp \{ - \frac{1}{2} {( x - μ \}}^{l} ) {\sum }^{- 1} ( x - μ ) \qquad ( Eq . 5 )$$

where μ is an average of the teaching pixels

$$μ = \frac{1}{n} {\sum }_{i = 1}^{n} {x}_{i}$$

Σis covariance Σ=Σᵢ₌₁ⁿ(xᵢ−μ)(xᵢ−μ)′

Discrimination Function

φ(x)=1(if p(x)≧th then non-defect)

0(if p(x)<th then defect) (Eq. 6)

Also, as an example of the case, where the features of the non-defect pixel cannot be presumed in the form of the parametric distribution model can be applied a method, such as, a 1^{st} class SVM (Supper Vector Machine), etc. This maps the feature space made up with the non-defect pixels, upon which the teaching is made, into a density space. And then, the discrimination function φ is calculated, while letting a hyperplane having a maximum margin for separating an original point of the density space and the distribution of the non-defect pixel to be the discriminant function (but, the equation thereof is omitted herein). As was explained in FIG. 7(b), by adding the teaching of the non-defect pixel, the parameters of the discriminant function can be renewed. The user repeats the renewal of the parameter of the discriminant function by the teaching, until when no non-defect can be detected as the defect candidate. In case where a desired defect can be found out, in the test inspection, the teaching may be made that it is the defect, on a menu of the screen 88 shown in FIG. 8. However, those teachings are made through the teaching data setup portion 18-5 shown in FIG. 3.

Next, when new data is inputted, as is in the processing flow of the defect candidate detector portion 18-2 shown in FIG. 6, calculation is made on the feature quantity between the reference image, and determines on if it lies in an inside or an outside of the discriminant function renewed upon basis of the defect candidate, upon which the teaching is made; i.e., the non-defect or the defect in accordance with the discrimination function φ. In this manner, according to the present invention, with making the teaching of what should not be detected (i.e., the non-defect), it is possible to detect the pixel, characteristically differing from that, upon which the teaching is made, i.e., the pixel, which the user wishes to detect.

Further according to the present invention, within the defect candidate detector portion 18-2 shown in FIG. 1, it is also possible to extract only a desired defect kind, among from the various kinds of defect candidates to be detected. The number and the kinds of detects come to be huge if advancement is achieved on the high-sensitivity of the device, there will be a possibility that the user cannot find out detect that he/she truly wishes to do, because it is buried within a large amount of the unnecessary defects. For this reason, with teaching that the unnecessary defects to be detected by a large amount thereof are unnecessary (i.e., the non-defect), extraction is made only on the other(s), i.e., the defect (s), which is/are truly necessary. This process is executed within the defect extractor portion 18-3 shown in FIG. 3.

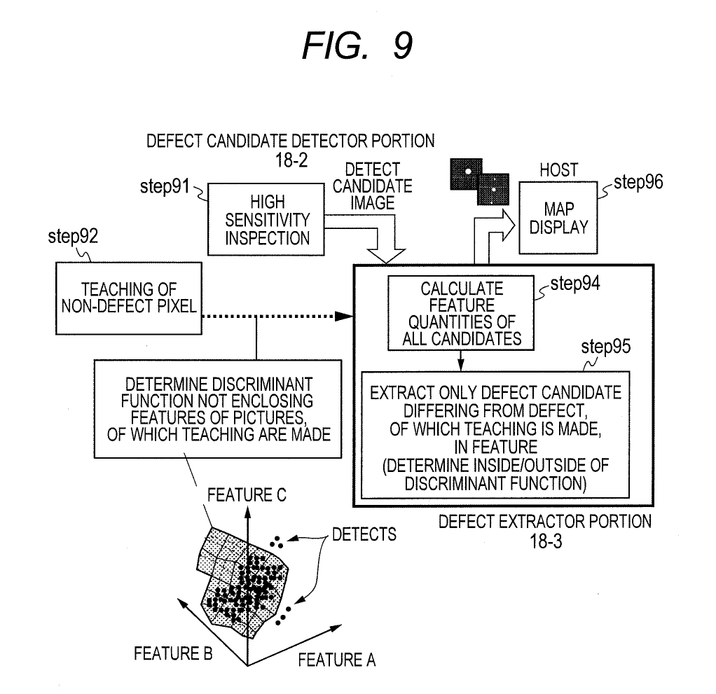

The processes for extraction of the defect will be explained by referring to FIG. 9. First of all, in the defect candidate detector portion 18-2, a high-sensitivity inspection is made with using such a low discriminant function that also the minute detect can be detected (step 91). With this, as is shown in FIGS. 5(a) and 5(b), a large number of the minute defects can be detected, including a large number of the noises and/or the unnecessary defect kinds, together. That detected in the defect candidate detector portion 18-2 is cut out into a small image including the portion corresponding to the defect candidate and the periphery thereof, and a small image of the reference image at the position corresponding thereto, in a set, as the defect candidate image, and they are inputted into the defect extractor portion 18-3.

The user observes image(s) of the detected defect candidate(s) by an arbitrary number of pieces (or, of points) thereof, and makes the teaching of the non-defect pixel (step 92). A manner of the teaching is as follows. Herein, the teaching may be made on both the defect and the non-defect. In the defect extractor portion 18-3, from the images of the defect candidates, which are taught to be the non-defects is determined the discriminant function for not detecting that/those (step 93). And then, upon all of the defect candidates, which are detected, the feature quantities are calculated (step 904), and then determination is made for each defect candidate on whether it lies in an inside of the calculated discriminant function (i.e., being the non-defect), or in an outside of the discriminant function (i.e., being the defect) on the feature space (step 95), thereby extracting only that lying in the outside, to be outputted to the total controller portion 19, and then to be displayed in the form of the map, as a final inspection result (step 96).

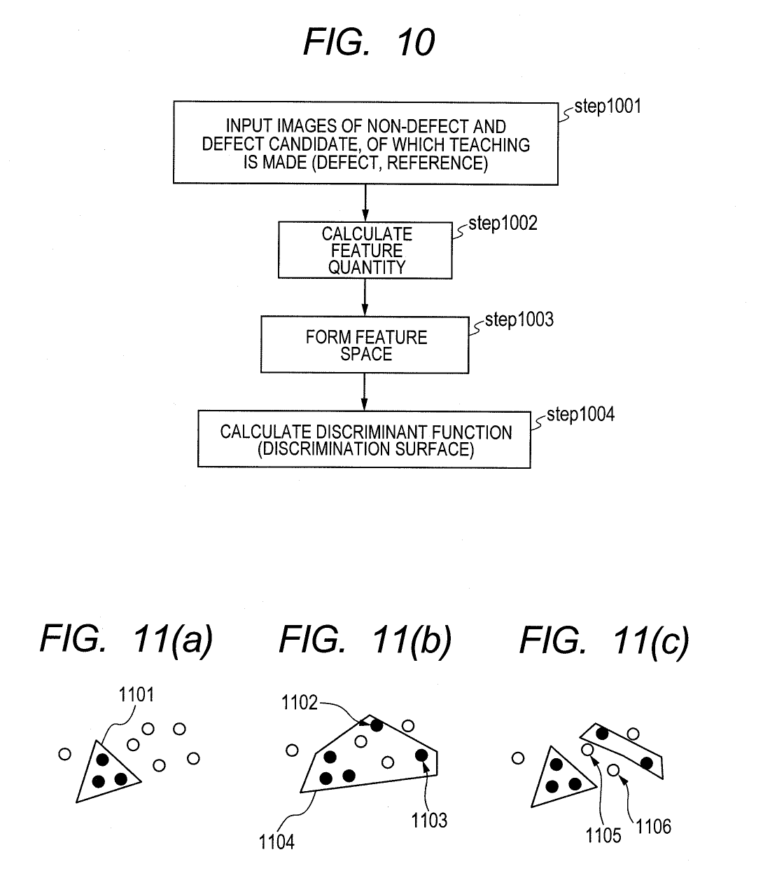

FIG. 10 shows an example of a method for setting up the discriminant function of the defect extractor portion 18-3 shown in FIG. 1. First of all, when the non-defect and the defect candidate pixel (i.e., the small image, which is cut out to include the defect therein, and the reference image) are inputted (step 1001), the feature quantities are calculated out, from each defect candidate pixel, (step 1002). The feature quantities may be those explained by the Eq. 1 to Eq. 4, or other than that, they may be those for indicating the features of each defect kind. According to the present invention, it is also possible to prepare those in a large number, and to select one (s) suitable for the defect kind, on which the teaching is made. And, the non-defect and the defect candidate, on which the teaching is made, are plotted on the space adopting the feature quanity as an axis thereof (step 1003), then calculation is so made on the discriminant (or discrimination) function that it does not include those (step 1004).

The calculation method may follow the Eqs. 5 and 6 mentioned above, or may follow the 1^{st} class SVM, too. Determination of the discriminant function of the defect extractor portion 18-3 may be made at the same timing to that of setting the threshold value in the defect candidate detector portion in accordance with the test inspection shown in FIG. 7, and after inspection of all chips (or, all surfaces) of the step 77 shown in FIG. 7, only the defect (s) desired by the user can be detected. Also, if reserving all images of the defect candidates, it is also possible, while watching a result of the inspection of all chips, to add the teaching of the defect candidates, to determine the discriminant function to high accuracy, again, and to make a tuning on the defect extracting process in the defect extractor portion 18-3.

FIGS. 11(a) to 11(c) show an example of the tuning in the defect extracting process, by an additional teaching of the non-defect or the defect. FIG. 11(a) is a schematic view of the discriminant function on the feature space. Three pieces of lack points are those, which are taught to be the non-defects, and an envelope 1101 is defined surrounding those three (3) points, wherein five (5) points (white points) lying in an outside thereof are extracted as the defects. FIG. 11(b) shows an example, in particular, when the additional teaching is made. When making the additional teaching so as to bring tow (2) points 1102 and 1103 to be the non-defect, the discriminant function is expanded, to be defined as an envelope 1104, and then two (2) points (white points) lying in an outside thereof are extracted as the defects. FIG. 11(c) shows an example where the teaching is made of the defects. When making the additional teaching that two (2) points 1105 and 1106 are the defects, the discriminant function is divided into two (2), and therefore it is also possible to extract the defect and also the two (2) points, upon which the teaching is made. In this manner, by executing the teaching of the non-defect and the teaching of the defect, additionally, it is possible to determine the discriminant function having much higher accuracy, and thereby to extract the desired defect kind with high-sensitivity.

Herein, in the defect extractor portion 18-3 shown in FIG. 1, calculation is executed of the feature quantity from the defect candidate image, and although mentioned about the example of executing the defect extraction, in the defect candidate detector portion 18-2, all the feature quantities are calculated and reserved when extracting the defect candidate(s), and thereafter, in the defect extractor portion 18-3, it is also possible to execute the defect extraction with using those feature quantities. Also, the defect extractor portion 18-3 is constructed with plural numbers processors, and executes the determination on whether the defect or the non-defect, upon the defect candidate images, in parallel with.

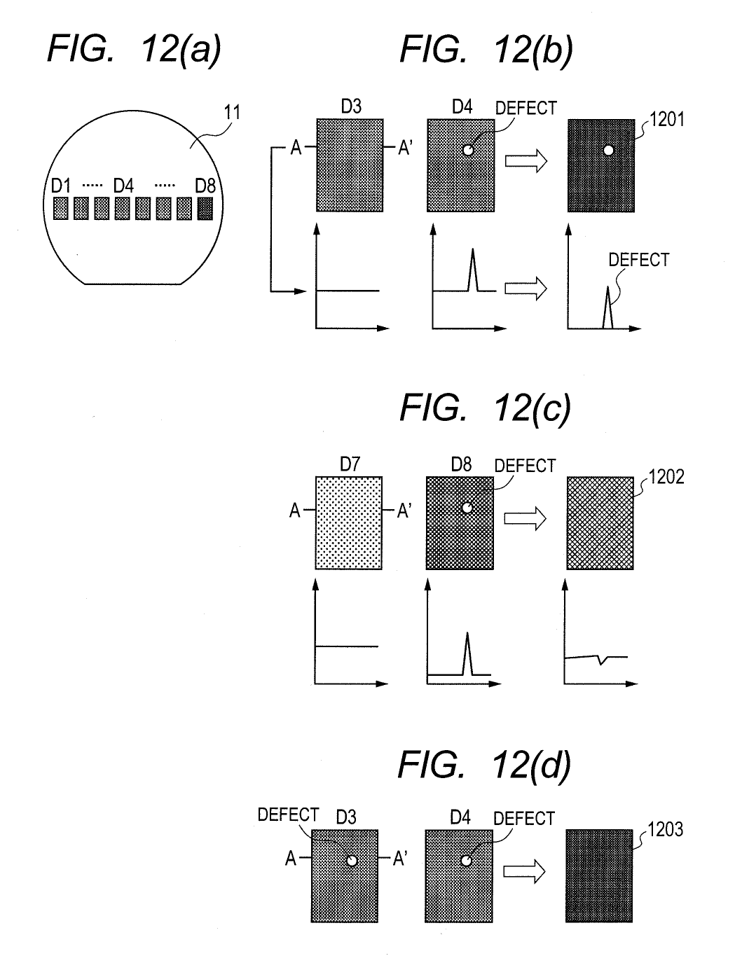

According to the invention mentioned above, although mentioning was made on the example of detecting a small number of the defects desire by the user, being buried within the noises and the large number of the unnecessary defects, by making the teaching that they are the non-defects; however, further effect(s) will be mentioned below. FIG. 12(a) shows that eight (8) pieces of chips D1 to D8 are formed on the semiconductor wafer. Although difference of film thickness is small between the chips in a central portion of the semiconductor wafer, and then difference in the brightness of the normal pattern is also small between the images to be compared with. Accordingly, as is shown in FIG. 12(b), comparing the brightness between the neighboring chips (D3, D4), it is possible to detect the defect, only (1201). On the contrary to this, the film thickness is large on the chips (D7, D8) near to an end of the semiconductor wafer, and then the difference also comes to be large in the brightness of the normal pattern noise between the images (FIG. 12(c)). With this, being buried within the difference of the brightness of background, there is a possibility that the defect cannot be detected (1202). Also, even with the chips (D3, D4) laying in the central portion of the semiconductor wafer having a small difference of the brightness, as is shown in FIG. 12(d), detection is difficult, also when the defects locate at the same position on both chips. In the similar manner, the detection is difficult also when all of the defects locate at the same position on all of the chips. In this manner, according to the present invention, detection can be also made even upon the defect of the chip locating on the edge of the wafer, a repeating defect generating at the same position on each of the chips, detections of which are difficult with using the comparison between chips.

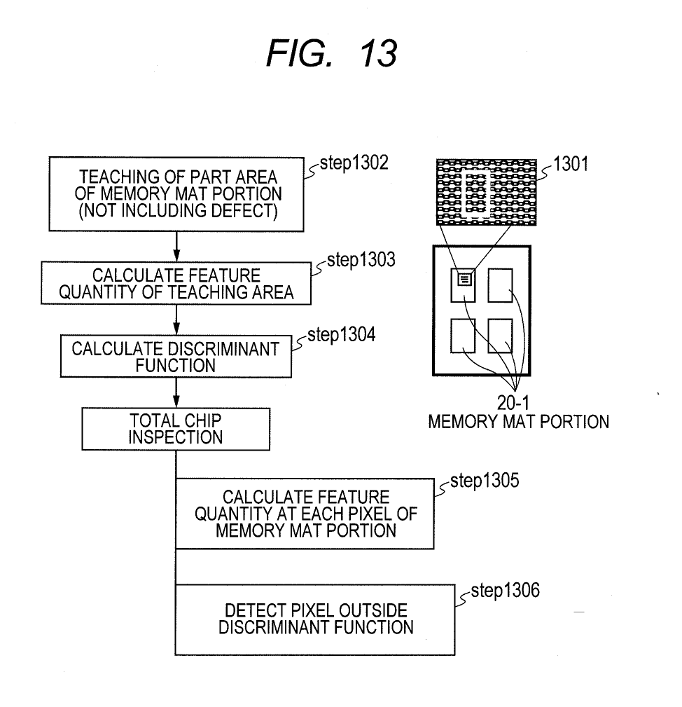

FIG. 13 shows an example of the process for detecting the defect, detection of which is inherently difficult to detect with using the feature comparison between the chips, but according to the present invention. In the memory mat portion 20-1 shown in FIG. 2(b), being called a cell, a minute and same pattern is formed, repetitively. For this reason, the teaching is made that a normal area 1301 in a part of the memory mat portion 20-1 is the non-defect (step 1302). In this instance is also made the teaching of not including the defect. Once the teaching is made of the normal area, then calculation is made on the feature quantity of the normal area, upon which the teaching is made (step 1303). And, as was mentioned heretofore, in the feature space, calculation is made on the discriminant function surrounding the distribution of the normal area (step 1304). In this manner, the discriminant function is calculated, in advance, for discriminating the normal area of the memory mat portion. And, in a total chip inspection, the feature quantity is calculated of each pixel of the memory mat portion (step 1305), and then detection is made on the pixel differing from the normal pattern, characteristically, of which the teaching is made, i.e., the pixel laying in an outside of the discriminant function on the feature space (step 1306). In this manner, the feature quantity is compared with the normal pattern, of which the teaching is made, and the feature off value (i.e., the pixel existing outside the discriminant function) is detected as the defect candidate, and thereby it is possible to detect the detect (s), the detection of which is difficult with the conventional feature comparison (in particular, the brightness) between the chips.

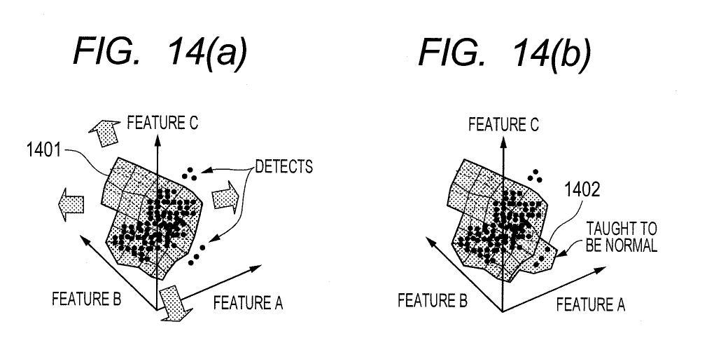

In the above, although the mentioning was made about the example of detecting a coming out from the distribution of the non-defects, of which the teaching is made on the feature space, as the detect, after calculating the discriminant function only with the teaching of the non-defects; however, according to the present invention, it is also possible to adjust the sensitivity. An envelope surface 1401 shown in FIG. 14(a) is the discriminant function calculated from the teaching data. In general, the discriminant function is calculated under the condition that there is almost no likelihood from the teaching data. With conducting expansion or shrinkage of this envelope surface, it is possible for the user to adjust the sensitivity. Also, the envelope surface shown in FIG. 14(b) is the discriminant function when an additional teaching is made that the defect candidate(s) lying outside the discriminant function, which is calculated in FIG. 14(a), is/are the non-defect(s). In this manner, with doing the additional teaching, it is also possible to adjust the sensitivity with respect to a part of the features, finely.

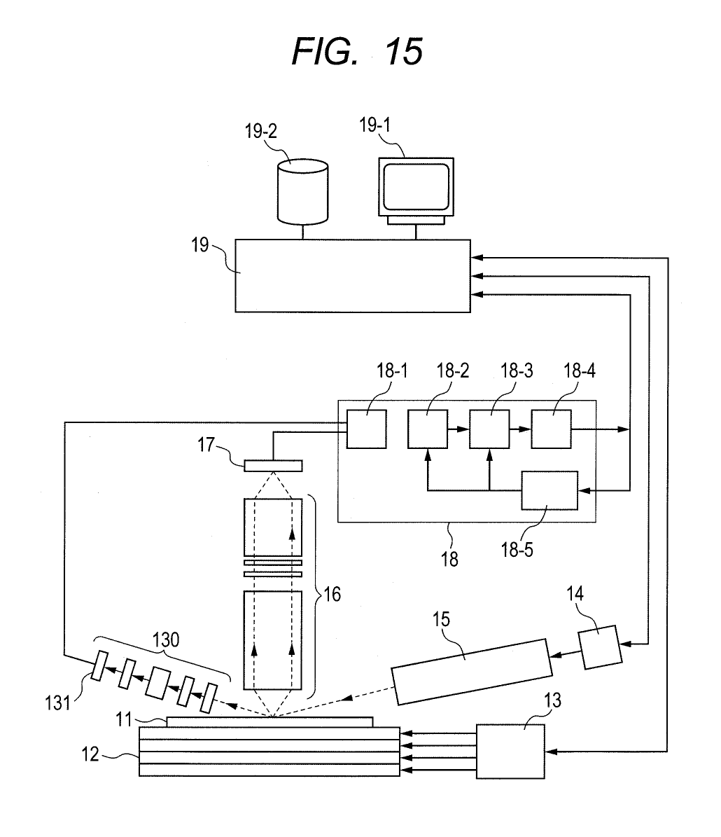

Heretofore, although the mentioning was given on the method for determining the defect with using the image obtained by only one (1) detector; however, the defect inspection method according to the present invention may have a means for detecting plural numbers of images by the detector. FIG. 15 shows an example, wherein a number of detection optic systems becomes two (2) with the detect check device with using the dark-field illumination shown in FIG. 1. It has an oblique detection system (i.e., the detection optic system) 130 shown in FIG. 15, and thereby, in the similar manner to that of the detection optic system 16, achieving an image forming of scattering lights from the semiconductor wafer and receiving the image of scattering lights by a image sensor 131, so as to convert it into a image signal. The image signal obtained is inputted into the same image processor portion 18 being similar to upper detection system, thereby to be processed. Herein, the images picked up by the two (2) different detection systems differ from, of course, in the image quality thereof, and also differ from in the kind of the defect to be detected, in part. For this reason, by executing the detection of the defect with unifying or combining information of each detection system, it is possible to detect further various kinds of defects.

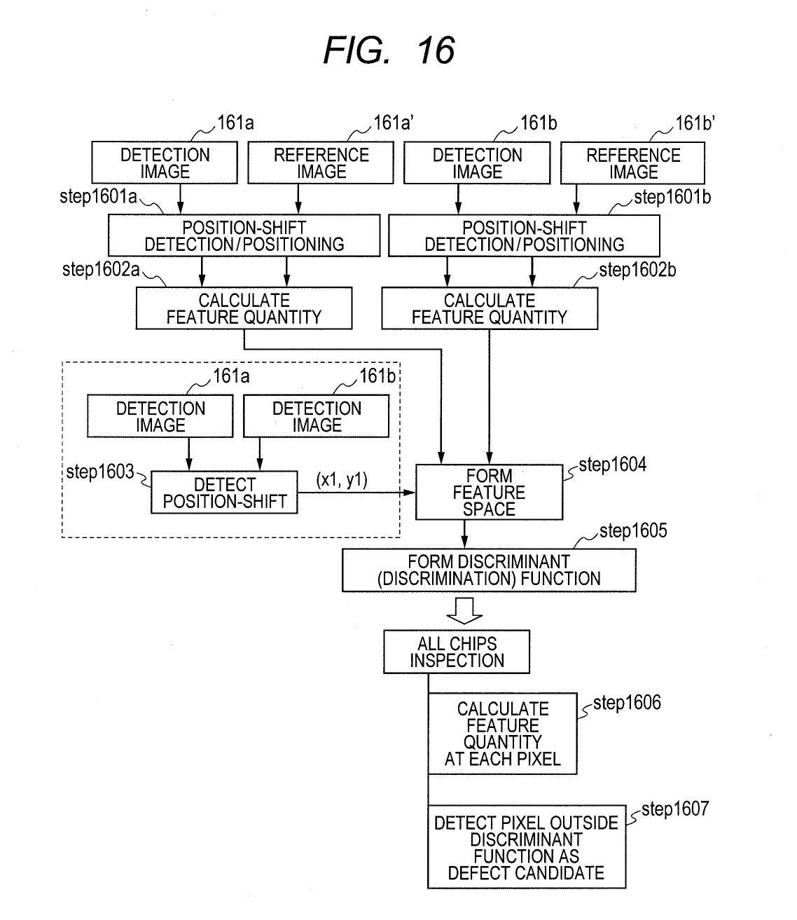

FIG. 16 shows a flow of processes for detecting the defects, with combination of two (2) pieces of image information obtained from the different two (2) sets of detection optic systems. As was mentioned above, although the defect candidate detection process and the detect extraction process are executed, respectively, by the plural numbers of processors, in parallel; however, into each processor is inputted the images in a set, which are obtained by picking up the same position by the different detection optic systems, thereby to execute the detection process on the detects. Firstly, in relation to the pixels, which are taught to be the non-defects, detection is made of a positional shift between a small-area image (e.g., the detection image) 161a, including a target pixel obtained by the detection optic system 16 shown in FIG. 15 and a reference image 161a′ thereof, so as to execute a positioning thereof (step 1601a). Next, upon the target pixels of the detection image 161a, on which the positioning is made, the feature quantity is calculated between the pixel of the reference image 161a′ corresponding thereto (step 1602a). In the similar manner, also the same positioning is conducted on a small-area image (e.g., the detection image) 161b and a reference image 161b′ thereof, and the calculation of feature quantity on the target pixels (step 1601b, step 1602b).

Herein, if the images of the detection optic system 16 and the detection optic system 130 are taken, in time-series, then also the positional shift is calculated between the detection images 161a and 161b (step 1603). And then, by adding the positional relationship between the images of the detection optic system 16 and 130 into the consideration, selection is made for all or a several of the feature quantities of the target pixels, and thereby forming up the feature space (step 1604). The feature quantities are calculated out from the respective sets of the respective images, such as, (1) brightness, (2) contrast, (3) shading or tonic difference, (4) a brightness distribution value of the pixel in vicinity, (5) a correlation coefficient, (6) increase/decrease of brightness comparing to the pixel in vicinity, and (7) a secondary differential value, etc., as was mentioned above. In addition thereto, the brightness of each images themselves (i.e., the detection image 161a, the reference image 161a′, the detection image 161b and the reference image 161b′) are used as the feature quantities. Also, with combination of the images of each detection systems, the feature quantity (1) to (7) may be obtained from, such as, from an average value of the detection images 161a and 161b and the reference images 161a′ and 161b′, etc., for example. Herein, explanation will be made about an example when selecting two (2), i.e., a brightness average Ba calculated from the detection image 161a and the reference image 161a′ and a brightness average Bb calculated from the detection image 161b and the reference image 161b′, as the feature quantity. In case where the position shift of the detection image 161b with respect to the detection image 161a is (x1, y1), then the feature quantity calculated from the detection optic system 130 is Bb (x+x1, y+y1), with respect to the feature quantity Ba (x, y) calculated from the detection optic system 16. For this reason, the feature space is produced by plotting the values of all pixels, the teaching of which are made, in the 2-D space, with setting an X value to Ba (z, Y) and a y value to Bb (x+x1, y;y1). And, within this 2-D space is calculated the discriminant function enclosing the distribution of the teaching data therein (step 605).

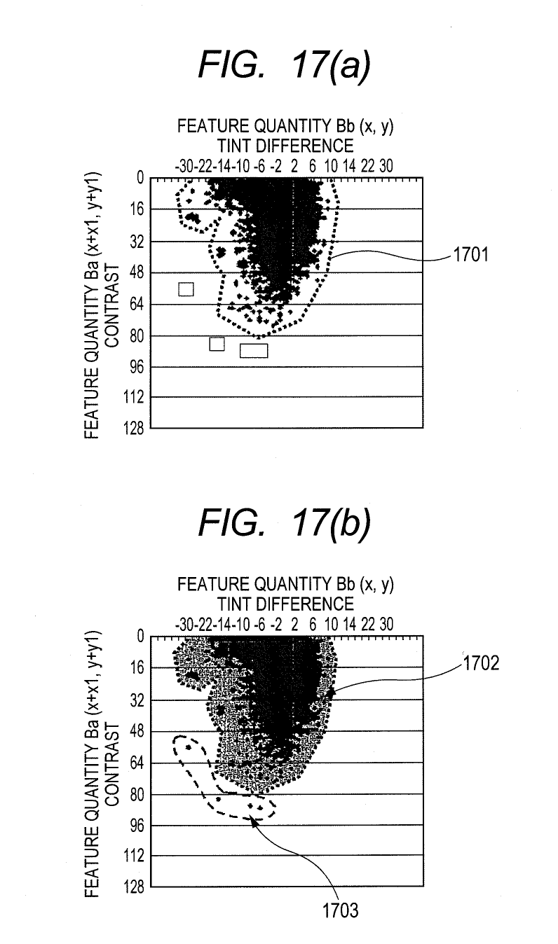

FIG. 17(a) an example of the feature space formed, wherein a broken line 1701 is the calculated discriminant function. And when inspecting all chips, the feature quantities Ba and Bb are calculated, in the similar manner, for all of the pixels of the object (step 1606), and determining the pixel(s) plotted outside of the calculated discriminant function as the defect candidate(s) (step 1607). In FIG. 17(b), the pixel(s) plotted in a meshed area 1702 is/are determined as the non-defect(s), while the other pixel(s) 1703 plotted other than those is/are detected as the defect candidate(s). In the present example, although the mentioning was made on determination of the discriminant function (the normal area) and detection of the defect candidates on the 2-D feature space, assuming that the feature quantities are two (2) in the number thereof; however, it is possible to select three (3) or more than that of the feature quantities, and thereby to expand them into N^{th} dimensional space.

As was mentioned above, according to the present invention, plural numbers of image signals, which are obtained upon receipt of the lights by means of the separate detection optic systems, are inputted into one (1) processor, and where the defect determination processes are executed therein. Since the images of those two (2) separate detection optic systems differ from, of course, in the distribution condition of the scattering lights thereof, and also differ from, in a part of the defect kinds, which are processed and detected, the information obtained from the separate detection optic systems are unified or combined with, for detecting the defects, and therefore it is possible to make more various defect kinds remarkable.

As was mentioned above, according to the check device explained in each of the embodiments of the present invention, the defect determination process by the image processor portion has the defect candidate detection portion and the defect extract portion, appropriately, wherein each of them is constructed with plural numbers of processors and executes the process in parallel. The defect candidate detection portion detects the data, of which the teaching is made, and the pixel, which differs from, characteristically, when the user makes the teaching about the non-defect, which can be obtained in a relatively ease, when conducting the test inspection. With this, it is possible to detect the defect candidate(s) at high accuracy with using the plural numbers of feature quantities, but without complicated setting of the condition. Also, when making the teaching that a part of the memory mat portion, which is formed with the similar repetitive patterns as the normal area, then the detection is made on feature off pixel(s) in the memory mat portion. With this, it is possible to detect the defect (s), which are difficult to be detected through comparison of the chips, such as, the defect(s) existing on the chop at an edge of the wafer, which differs from other chips, largely, in a manner of viewing thereof, due to the difference of film thickness, and/or a systematic defect(s), which generate at the same position of each chip, etc., for example.

Also, when the user makes teaching on the unnecessary detect(s), among from the defect candidates detected, extraction is made only upon the defect candidate(s) differing from the candidate(s), characteristically, of which the teaching is made. With this, it is possible to extract an important defect (s) desired by the user, which is/are buried within the unnecessary defects, without complicated setting of the condition.

Those processes can be also executed, after unifying or combining the images from the plural numbers of separate detection optic systems. With this, it is possible to detect various kinds of detects at high sensitivity. As the defect determination process through comparison of the chips, in the present embodiments, although there are shown only the examples of executing the comparing inspection, assuming the reference image is the image of the neighboring chip (e.g., the area 22 shown in FIG. 2(a); however, the reference image may be produced by only one, from an average value of plural numbers of chips (e.g., the areas 21, 22, 24 and 25 in FIG. 2(a)), etc., or the defect may be detected by conducting a statistical processing on all results of comparisons, after executing 1:1 comparison in plural numbers of areas, such as, the areas 23 and 21, the areas 23 and 22, . . . , the areas 23 and 25, etc., within a scope of the methods according to the present invention.

Also, even if there is a delicate difference in film thickness of the patterns after the process of flattering or planarization process, such as, CMP, etc., or a large difference in the brightness between the chips to be compared with due to short-wavelength of the illumination light; but, according to the present invention, it is possible to detect the defects 20 nm to 90 nm.

Further, even if there is a local difference of brightness due to variation of distribution of refractive index in the films, within an inspection of a “low k” film, such as, an inorganic insulation film, including SiO₂, SiOF, SiOB and a porous silica film, or an organic insulation film, including SiO₂ containing a methyl group, MSQ, a film of polyimide group, a film of Parellin group, a film of Teflon (®) and a film of amorphous carbon, etc, according to the present invention, it is possible to detect the defects 20 nm to 90 nm.

As was mentioned above, although the explanation was given on the example of the comparison inspection images in the dark-field illumination check device for targeting the semiconductor wafer, as an example of the present invention; however, the present invention can be also applied to a comparison image in an electron-type pattern inspection. Also, it can be applied to a pattern check device of the dark-field illumination.

The object to be inspected should not be limited to the semiconductor wafer, but it is also applicable onto one, the defect of which should be detected with comparison of images, for example, a TFT substrate, a photo mask, a printed board, etc.

What is claimed is:

1. A defect inspection method for inspecting a defect(s) on an object to be inspected, comprising the following steps of:
a step for obtaining detected image of a pattern of said object to be inspected with irradiation under a predetermined optical condition upon said object to be detected;
a step for determining a parameter of discriminant function to be formed upon basis of feature quantity, which is calculated from detected image; and
a step for detecting a defect on said object to be inspected, with using said discriminant function to be formed upon basis of the parameter, which is determined in said step for determining the parameter, wherein
said step for determining the parameter includes:
a step for extracting a defect candidate on said object to be inspected with using said discriminant function with determining an arbitrary parameter; and
a step for automatically renewing the parameter of said discriminant function, upon basis of teaching of defect information relating to said defect candidate, which is extracted in said step for extracting said defect candidate.

2. The defect inspection method, as defined in the claim 1, wherein
the parameter of said discriminant function is automatically renewed while teaching only that said defect candidate is a non-defect, within said step for automatically renewing said parameter.

3. The defect inspection method, as defined in the claim 1, wherein
the parameter of said discriminant function is automatically renewed while teaching that said defect candidate is either a non-defect or a defect, within said step for automatically renewing said parameter.

4. The defect inspection method, as defined in the claim 1, wherein
the parameter of said discriminant function is automatically renewed, in such a manner that it includes said defect candidate, upon which the teaching is made to be the non-defect, within said step for automatically renewing said parameter.

5. The defect inspection method, as defined in the claim 1, wherein
the defect candidate is extracted depending on whether the feature quantity, which is calculated from said detected image, exists inside or outside said discriminant function, within said step for extracting said defect candidate.

6. The defect inspection method, as defined in the claim 1, wherein
said discriminant function is determined by repeating said step for extracting said defect candidate and said step for automatically renewing said parameter, within said step for determining the parameter.

7. The defect inspection method, as defined in the claim 1, wherein
said parameter is determined upon basis of plural numbers of parameters, within said step for determining the parameter.

8. The defect inspection method, as defined in the claim 1, wherein
said parameter is determined upon basis of plural numbers of parameters, which are set by a user arbitrarily, within said step for determining the parameter.

9. A defect inspection method for inspecting a defect(s) on an object to be inspected, comprising the following steps of:
a step for obtaining detected image of a pattern of said object to be inspected with irradiation under a predetermined optical condition upon said object to be detected;
a step for determining a first parameter of a discriminant function to be formed upon basis of feature quantity, which is calculated from detected image;
a whole surface inspection step for detecting defect candidates on a whole surface of said object to be inspected, with using said first discriminant function formed upon the parameter, which is determined in said step for determining the parameter of said first discriminant function;
a step for determining a second parameter to be formed upon basis of the feature quantity, which is calculated from pixel data in vicinity of said defect candidates detected in said whole surface inspection step; and
a step for inspecting the defect on said object to be inspected, by extracting only a desired defect among said defect candidates, with using said second discriminant function, which is formed upon basis of the parameter determined in said step for determining the parameter of said second discriminant function, wherein
said step for determining the parameter of said second discriminant function includes:
a step for detecting a defect candidate on said object to be inspected with using the first discriminant function, an arbitrary parameter of which is determined; and
a step for renewing the parameter of said first discriminant function, automatically, upon basis of defect teaching of defect information relating to the defect candidate, which is detected in said step for detecting the defect candidate, wherein
said step for determining the parameter of said second discriminant function includes:
a step for extracting one other than the non-defect from said defect candidates, with using the second discriminant function, the arbitrary parameter of which is determined; and
a step for renewing the parameter of said second discriminant function, automatically, upon basis of the defect information relating to the detected, which is extracted from said defect candidates in said step for extracting the defect.

10. A defect check device for inspecting a defect(s) on an object to be inspected, comprising:
a lighting portion, which is configured to irradiate under a predetermined optical condition upon said object to be inspected;
a detection optic system, which is configured to detect scattering light from said object to be inspected; and
an image processing portion, which is configured to determine a parameter of a discriminant function, which is formed upon basis of a feature quantity calculated from an image signal based on the scattering light detected by said detection optic system, and thereby detecting a defect on said object to be inspected with using said discriminant function formed upon basis of said parameter determined, wherein
said image processing portion has a defect candidate detection portion, which is configured to extract a defect candidate on said object to be inspected with using said discriminant function, the parameter of which is determined, and determines the parameter of said discriminant function by renewing the parameter of said discriminant function, automatically.
